(19) United States
(12) Patent Application Publication
(10) Pub. No.: US 2016/0138624 A1
(43) Pub. Date: May 19, 2016

(54) Hydraulic Power System with Aeration Sensing for a Mobile Machine

(71) Applicant: Caterpillar Inc., Peoria, IL (US)

(72) Inventor: James Oftelie, Monee, IL (US)

(73) Assignee: CATERPILLAR INC., Peoria, IL (US)

(21) Appl. No.: 14/541,973

(22) Filed: Nov. 14, 2014

(51) Int. Cl. F15B 21/04; B60P 1/16; F15B 19/00; F15B 11/10; F15B 20/00

(52) U.S. Cl. CPC F15B 21/044; F15B 11/10; F15B 20/00; F15B 19/005; B60P 1/162; F15B 2211/857; F15B 2211/86

(57) ABSTRACT

A hydraulic power system for a mobile machine is provided. The system includes a load configured to be driven by pressurized hydraulic fluid and a hydraulic pump operatively connected for supply pressurized hydraulic fluid to the load. An engine is operatively connected and configured to drive the hydraulic pump. An aeration sensing system includes a sonic sensor system having a plurality of bands arranged on an outer surface of a line carrying pressurized hydraulic fluid and a pressure sensor for sensing a pressure of the hydraulic fluid in the line. A controller is in communication with the sonic sensor system and the pressure sensor and configured to calculate a level of aeration in the hydraulic fluid in the line during mobile machine operation using speed of sound data from the sonic sensor system and pressure data from the pressure sensor.

### TECHNICAL FIELD

This patent disclosure relates generally to hydraulic systems for mobile machines and, more particularly, to a hydraulic system for powering a load of a mobile machine that determines the level of aeration in the aeration in the hydraulic fluid.

### BACKGROUND

Hydraulic systems are commonly used on mobile machines associated with industries such as mining, construction and agriculture. Some examples of such machines include dump trucks, loaders and excavators. In a hydraulic system on these types of machines, the condition of the hydraulic fluid can be a very important factor in system performance and longevity. Air is one contaminant that can adversely affect the condition of hydraulic fluid. Air in a hydraulic system can include free air pockets trapped in the system, entrained air in the form of bubbles in the hydraulic fluid and air dissolved into the hydraulic fluid. Free and entrained air may get into the system in a variety of different ways, such as violent agitation, a leak in a connection or seal, or the release of dissolved air due to a pressure drop (e.g., at pump inlets).

It is well known that the presence of air (or other gases) in a system, such as a hydraulic system, can adversely impact the performance of components of the system as well as the overall system itself. Moreover, aeration in a hydraulic system may lead to premature failure of components of the hydraulic system. For example, aeration may reduce the efficiency and consistency of a hydraulic liquid in transferring energy. The movement of the air through one or more liquid channels in the system also can cause unwanted noise. Aeration can also disrupt the expected heat transfer properties of the system. Other problems of aeration in a liquid channel can include changing the natural frequency of the system, the loss of lubricity, oxidation of system components, and excessive wear on system components (e.g., pumps). A hydraulic system with elevated levels of aeration can lead to inefficiency that makes the machine more costly to operate, while premature failure of such system components due to aeration can lead to increased service cost and greater operational downtime for machines.

Several methods have been developed that are capable of quantifying a level of aeration in a liquid. However, none of these methods have had much success in quantifying aeration in a pressurized hydraulic system used on a mobile machine for industries such as mining, construction and agriculture. In particular, several of these methods require taking a sample of liquid and then performing various measurements on the sample to determine the level of aeration. However, such methods are too time consuming, costly and labor intensive to be practical in a mobile machine application. Moreover, the measurements are performed outside of the context of the operation of the hydraulic system on the machine and thus can lead to misleading results.

Other methods for determining levels of aeration in a liquid involve installing sensors or other measurement devices in the fluid itself. One such method is disclosed in commonly owned U.S. Pat. No. 8,250,902 (“the '902 patent”) which discloses the use of an ultrasonic transducer that is capable of sending and receiving an ultrasonic wave in a liquid channel. Analysis of the ultrasonic echo in the liquid channel is used to determine a level of aeration in the fluid. The '902 patent teaches that the transducer should be inserted into the liquid in order to avoid having to calibrate the measurement system to take into account the size and materials of construction of the channel. However, inserting the transducer or some other type of measurement device into the flowing hydraulic fluid can itself adversely impact the performance of a hydraulic system by introducing an obstruction into the system. Moreover, a pressurized hydraulic fluid can be a harsh environment for sensitive measurement devices and, as a result, such devices may not have a particularly long life requiring frequent repair and replacement.

As a result of these problems with prior systems, the issue of aeration in hydraulic fluid power systems has largely been dealt with on a trial and error basis using tools such as computer simulations and special laboratory tests and applications.

### SUMMARY

In one aspect, the disclosure describes a hydraulic power system for a mobile machine. The system includes a load configured to be driven by pressurized hydraulic fluid and a hydraulic pump operatively connected for supply pressurized hydraulic fluid to the load. An engine is operatively connected and configured to drive the hydraulic pump. An aeration sensing system includes a sonic sensor system comprising a plurality of bands arranged on an outer surface of a line carrying pressurized hydraulic fluid. The sonic sensor system is configured to produce speed of sound data relating to a speed of sound in the hydraulic fluid in the line. A pressure sensor is configured to produce pressure data relating to a pressure of the hydraulic fluid in the line. A controller is in communication with the sonic sensor system and the pressure sensor and configured to calculate a level of aeration in the hydraulic fluid in the line during mobile machine operation using the speed of sound data and the pressure data.

In another aspect, the disclosure describes a method for operating a hydraulic power system of a mobile machine that is configured to power operation of a load associated with the mobile machine. The method includes the step of sensing a speed of sound in a line carrying pressurized hydraulic fluid that is in communication with the load using a sonic sensing system including a plurality of bands arranged on an outer surface of the line. A pressure of the hydraulic fluid in the line is sensed. A machine parameter associated with operation of an engine of the mobile machine or a hydraulic device of the hydraulic power system is monitored. A level of aeration in the hydraulic fluid in the line is calculated using the speed of sound in the line and the pressure of the hydraulic fluid in the line. The calculated level of aeration in the hydraulic fluid in the line is compared to a reference value of aeration. The calculated level of aeration is recorded in memory in association with the machine parameter. An action is commanded if the calculated level of aeration exceeds the reference value of aeration.

In yet another aspect, the disclosure describes a mobile machine including a chassis, a plurality of ground engaging elements supported by the chassis for propelling the mobile machine and a work implement supported on the chassis. A hydraulic power system includes a hydraulic pump supplying pressurized hydraulic fluid to drive at least one of the work implement and the ground engaging elements and an engine operatively connected and configured to drive the hydraulic pump. An aeration sensing system includes a sonic sensor system comprising a plurality of bands arranged on an outer surface of a line carrying pressurized hydraulic fluid, the sonic sensor system being configured to produce speed of sound data relating to a speed of sound in the hydraulic fluid in the line. A pressure sensor is configured to produce pressure data relating to a pressure of the hydraulic fluid in the line. A controller is in communication with the sonic sensor system and the pressure sensor and configured to calculate a level of aeration in the hydraulic fluid in the line during mobile machine operation using the speed of sound data and the pressure data.

### BRIEF DESCRIPTION OF THE DRAWINGS

FIG. 1 is a schematic side view of an exemplary mobile machine according to the present disclosure.

FIG. 2 is a schematic diagram of a hydraulic power system such as for use with the mobile machine of FIG. 1.

FIG. 3 is a flow chart illustrating one method of controlling a hydraulic power system according to the present disclosure.

### DETAILED DESCRIPTION

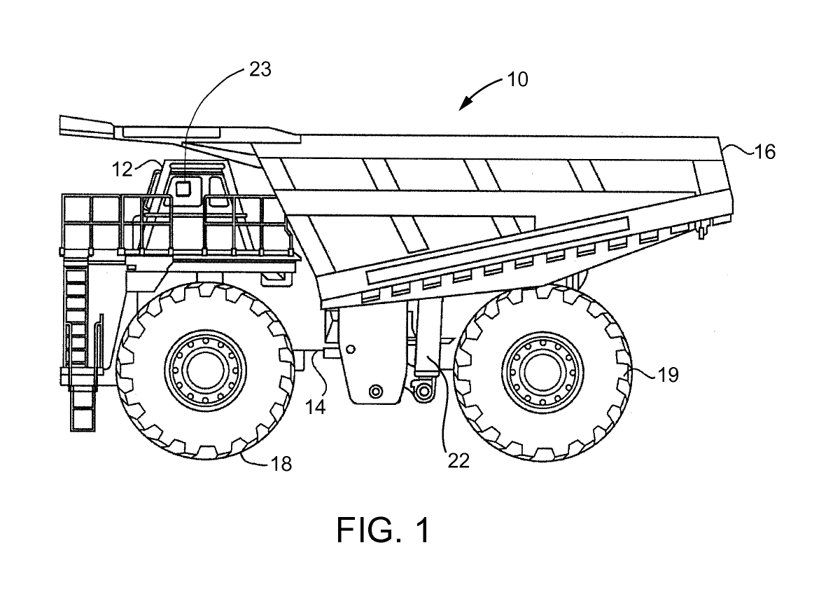

This disclosure generally relates to a hydraulic power system for transmitting power to a load of a mobile machine and associated method for controlling such a hydraulic system that determines a level of aeration in the hydraulic fluid. With particular reference to FIG. 1, an exemplary mobile machine 10 is shown. In this case, the exemplary mobile machine 10 is a dump truck, such as may be used transport material from one location to another at a work site such as a mine or construction site. The illustrated mobile machine 10 includes an operator cab 12, a chassis 14 and a truck body 16 that may be configured for carrying a load. The chassis 14 may have coupled thereto a front set of ground engaging propulsion elements 18 and a back set of ground engaging propulsion elements 19. In the illustrated embodiment, the propulsion elements 18, 19 include a set of front wheels and a set of back wheels, although other propulsion elements could be used including, for example, tracks located on the side of the mobile machine, a belt or any other drive traction device.

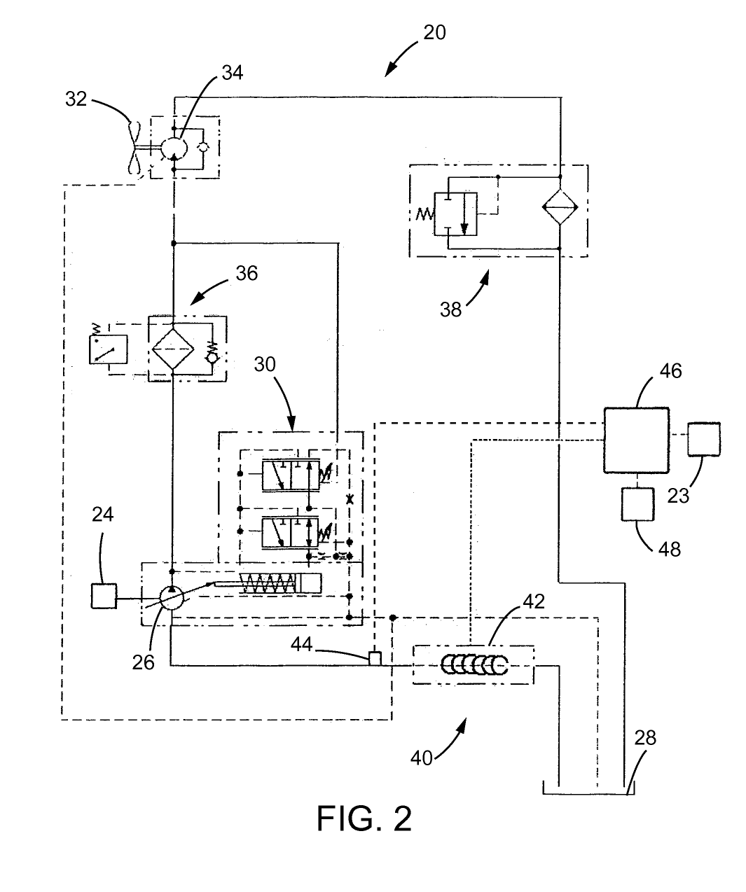

To allow a load carried within the body 16 to be dumped, the body 16 may be pivotally attached to the chassis 14 for movement between raised and lowered positions. A hydraulic power system 20 (an exemplary embodiment of which his shown schematically in FIG. 2) may be provided that is capable of powering such movement of the body 16. More particularly, with reference to the embodiment illustrated in FIG. 1, the mobile machine 10 may include one or more hydraulic lift actuators 22 that may be extended to raise the body 16 between the raised and lowered positions. Although only one hydraulic lift actuator 22 is visible in FIG. 1, one or more additional hydraulic actuators may be provided to assist in lifting the body 16 including, for example, a hydraulic actuator on the side of the mobile machine 10 opposite the side illustrated in FIG. 1. Each hydraulic lift actuator 22 may be attached at first end to the chassis 14 and at a second end to the body 16 and arranged with respect to the chassis 14 and body 16 such that extension and retraction of the hydraulic lift actuator 22 causes the body 16 to pivot about its pivotal connection to the chassis 14 between the raised and lowered positions. Each hydraulic lift actuator 22 may be powered by supplying and draining pressurized hydraulic fluid from the cylinders on either side of a piston to cause reciprocating movement of the piston within the cylinder. It will be understood that in addition to at least one hydraulic lift actuator 22, one or more non-hydraulic actuators may be provided. One or more of the hydraulic lift actuators also may comprise any other type of device configured to receive pressurized hydraulic fluid and convert it into a mechanical force and motion. For example, one or more of the hydraulic lift actuators 22 may additionally or alternatively include a fluid motor or hydrostatic drive train.

While the hydraulic power system 20 is illustrated in FIG. 2 and described in connection with powering dumping movement of a truck body, it will be appreciated that the hydraulic power system 20 could also be configured to power propulsion of the mobile machine 10 across a surface or power additional or different work implements. In this regard, the disclosed systems and methods are applicable to any type of mobile machine that has a load, such as a propulsion system or a work implement, powered by a hydraulic system. In this regard, the term “machine” may refer to any machine that performs some type of operation associated with an industry such as mining, construction, farming, transportation, or any other industry known in the art. For example, the mobile machine 10 may be an truck, agricultural vehicle or earth-moving machine, such as a wheel loader, excavator, dump truck, backhoe, motor grader, material handler or the like. The present disclosure is also applicable to hydraulically powered implements that may be utilized for a variety of tasks, including, for example, loading, compacting, lifting, brushing, and include, for example, buckets, compactors, forked lifting devices, brushes, grapples, cutters, shears, blades, breakers/hammers, augers, and others.

The operator cab 12 may include a operator control station that may include a variety of operator input devices for controlling operation of the mobile machine 10 including operation of the hydraulic power system 20. An operator input device may be located, for example, in close proximity to an operator's seat. The operator input device may embody any one of numerous devices that control functions of the mobile machine 10. In one example, the operator input device may embody a joystick controller. It is contemplated, however, that operator input device may embody additional or different control devices such as, for example, pedals, levers, switches, buttons, wheels, and other control devices known in the art. The operator input device may be manipulated to generate signals indicative of a desired output of the hydraulic power system 20. The operator station may further include a display 23 (shown schematically in FIG. 1) for monitoring operation of the hydraulic power system 20 and other aspects of the mobile machine.

To generate power, the hydraulic power system 20 may include one or more power sources. For example, the power source may include an internal combustion engine 24 such as, for example, a compression-ignition engine, a spark-ignition engine, a gas turbine engine, a homogeneous-charge compression ignition engine, a two-stroke engine, a four-stroke, or any type of internal combustion engine known to those skilled in the art. The engine 24 may be configured to operate on any fuel or combination of fuels, such as, for example, diesel, bio-diesel, gasoline, ethanol, methanol, or any fuel known to those skilled in the art. Further, the internal combustion engine may be supplemented or replaced by another power source such as a hydrogen-powered engine, fuel-cell, solar cell, and/or any power source known to those skilled in the art. For example, an electric motor/generator may be coupled to the engine 24, such that engine 24 drives motor/generator, thereby generating electric power.

The power or torque associated with the engine 24 may be distributed to one or more hydraulic devices that can drive a load on the mobile machine 10. As noted previously, in the illustrated embodiment, the load may include the at least one hydraulic lift actuator 22 that moves the body 16 of the mobile machine 10 between the raised and lowered positions. Alternatively, however, the load may comprise additional or other work implements and/or the ground engaging propulsion elements of the mobile machine 10. In the exemplary embodiment shown in FIG. 2, the engine 24 is coupled to a hydraulic pump 26 and the hydraulic pump 26 is, in turn, coupled to a hydraulic fluid source, in this case a hydraulic fluid reservoir 28, by suitable hydraulic fluid lines. The hydraulic pump 26 may pressurize the hydraulic fluid from the reservoir 28, which then may be provided to the hydraulic lift actuator 22 when it is desired to lift the body 16 to the raised position. Further, although the exemplary embodiment shown includes one pump, two pumps, or more than two pumps may be utilized. Additionally, the hydraulic power system 20 may include additional hydraulic pumps that may be devoted, at least in part, to other specific operations of the mobile machine 10. It will be appreciated that the hydraulic pumps in the hydraulic power system may operate as pumps and/or a motors, particularly when operating in a hybrid hydraulic system. For the purposes of this disclosure, however, such pumps/motors will be referenced as pumps.

While fixed displacement pumps may be utilized, in the illustrated embodiment, the hydraulic pump 26 is a variable displacement pump. The hydraulic pump 26 may be a swashplate-type pump and include multiple piston bores, and pistons held against a tiltable swashplate. The pistons may reciprocate in the bores to produce a pumping action as the swashplate rotates relative to the pistons. The swashplate may be selectively tilted relative to the longitudinal axis of the pistons to vary a displacement of the pistons within their respective bores. The angular setting of the swashplate relative to the pistons may be carried out by any actuator known in the art, for example, by a servo motor. Although the structure of the hydraulic pump 26 is not illustrated in detail, those of skill in the art will appreciate the structure, which is known in the art.

In the exemplary embodiment shown in FIG. 2, the hydraulic power system 20 includes control valves 30 that control the actuator that adjusts the angle of the swashplate of the hydraulic pump 26. For example, the discharge pressure from the hydraulic pump 26 can be communicated via signal lines to the control valve 30 which are moved accordingly to control the amount of movement of the swashplate and thus the pump displacement. The illustrated embodiment includes two control valves, one of which may be configured for pressure compensating and other of which may be configured for load sensing. For the purposes of this disclosure, the “control valves 30” may include one or more hydraulic valves that control and direct hydraulic flow to and from various hydraulic fluid connections.

In the illustrated embodiment, in addition to the hydraulic lift actuator 22, the hydraulic power system 20 may also include a hydraulic motor 34, e.g. to power a fan 32 that may be associated with the cooling system of the mobile machine 10. For example, the fan 32 may provide cooling for such machine systems as the engine 24, the hydraulic and diesel air inlets and air conditioning. The hydraulic motor 34 may be arranged downstream of the hydraulic pump 26 and in communication therewith via suitable hydraulic lines. The hydraulic motor 34 may be configured to convert the pressurized fluid from the hydraulic pump 26 into a rotational output for driving the fan 32. The illustrated hydraulic motor 34 is a fixed displacement motor, however it will be appreciated that a variable displacement motor also could be used.

The illustrated hydraulic power system 20 may further include a filter 36 and a heat exchanger 38. As shown in FIG. 2, the filter 36 may be arranged between the hydraulic pump 26 and the hydraulic motor 34 and may be operable to remove contaminants from the hydraulic fluid flowing in the system. The heat exchanger 38 may be arranged downstream of the hydraulic pump 26 and the hydraulic motor 34 and be operable to remove heat from the hydraulic fluid flowing in the hydraulic power system 20 before it returns to the reservoir 28. For example, operation of the hydraulic pump 26 and the hydraulic motor 34 may produce heat that can adversely influence the efficiency of the hydraulic power system 20. The heat exchanger 38 can remove this waste heat in order to help ensure that the hydraulic power system 20 operates efficiently.

For determining a level of aeration of the hydraulic fluid in the system, the hydraulic power system 20 may include an aeration sensing system 40 that may include a sonic sensor system 42, a pressure sensor 44 and an associated controller 46. The sonic sensor system 42 may be configured to produce data indicative of a speed of sound propagating through the hydraulic fluid in the hydraulic lines of the hydraulic power system 20. More particularly, the sonic sensor system 42 may include an array of pressure sensors (or transducers) spaced axially along an outer surface of a hydraulic line. In one embodiment, these sensors may be clamp-on, strain-based sensors in the form of a plurality of bands that can be lightly wound around the perimeter of one of the hydraulic lines of the hydraulic power system 20 as shown schematically in FIG. 2. The pressure sensors of the sonic sensor system 42 may measure the unsteady pressures produced by acoustical disturbances within the hydraulic line, which are indicative of the speed of sound propagating through the hydraulic fluid therein, and produce speed of sound data. The acoustical disturbances in the hydraulic line may be from sources such are produced by operation of the hydraulic power system 20 including, for example, the hydraulic pump 26, the control valves 30, the hydraulic motor 34 and/or other components of the hydraulic power system 20.

In one example, the sonic sensor may be placed external to the hydraulic fluid along a hydraulic line. For example, it can be configured as a plurality of bands that are arranged on an exterior surface of a hydraulic line. The sonic sensor system 42 may have no moving parts and does not require any penetration into the lines of the hydraulic power system 20 or any sampling of the hydraulic fluid. Thus, the sonic sensor system 42 has rugged design that is easy to install. The design of the sonic sensor system 42 also may allow it to be easily removed and then reinstalled on the same or another machine and also to be retrofitted onto existing hydraulic power systems.

The configuration of the sonic sensor system 42 also allows it to be very versatile with regard to its installation location within the hydraulic power system 20. More particularly, the sonic sensor system 42 may be placed at any location in the system where information about the aeration levels in the hydraulic fluid may be useful in diagnosing the performance or health of the hydraulic power system 20. For example, one or more sonic sensor systems 42 could be arranged in the hydraulic lines at the inlet and/or outlet to hydraulic devices such as the hydraulic pump 26 and/or hydraulic motor 34. One or more sonic sensor systems 42 also could be arranged in the hydraulic lines in proximity to the filter 36. In some embodiments, the sonic sensor system 42 can be bulky which may create issues with regard to where it may be located in the hydraulic power system 20. However, even if it is relatively bulky, there are numerous options regarding where the sonic sensor system 42 may be installed. For example, the location shown in FIG. 2, on a hydraulic line near the reservoir 28, is one location that can be used even with a more bulkily configured sonic sensor system 42.

The pressure sensor 44 associated with the aeration sensing system 40 may be arranged at any location in the hydraulic power system 20 where a reading to the pressure of the hydraulic fluid in the system may be made and may be configured to produce pressure data indicative of the pressure of the hydraulic fluid in the hydraulic power system 20. In the embodiment illustrated in FIG. 2, the pressure sensor 44 is arranged on a hydraulic fluid line near the sonic sensor system 42. In one exemplary embodiment, the pressure sensor 44 may comprise a pressure transducer.

The controller 46 for the aeration sensing system 40 may be located on the mobile machine 10 and may also include components located remotely from the mobile machine such as at a command center. The functionality of controller 46 may be distributed so that certain functions are performed at the mobile machine 10 and other functions are performed remotely. In such case, the controller 46 may include a communications system such as wireless network system for transmitting signals between the mobile machine 10 and a system located remote from the machine. Additionally, while the controller 46 is illustrated in FIG. 2 as a single unit, in other aspects the controller 46 may be distributed as a plurality of distinct but interoperating units, incorporated into another component, or located at a different location on or off the mobile machine 10. The term “controller” is meant to be used in its broadest sense to include one or more controllers and/or microprocessors that may be associated with the mobile machine 10 and that may cooperate in controlling various functions and operations of the mobile machine. The functionality of the controller 46 may be implemented in hardware and/or software without regard to the functionality. The controller 46 may rely on one or more data maps relating to the operating conditions and the operating environment of the mobile machine 10 and the work site that may be stored in the memory of controller. Each of these data maps may include a collection of data in the form of tables, graphs, and/or equations.

The controller 46 may be in communication with the sonic sensor system 42 and the pressure sensor 44 and be adapted to receive the speed of sound data produced by the sonic sensor system 42 and the pressure data from the pressure sensor 44. The controller 46 may be adapted to process the speed of sound data along with the pressure data and information that may be saved in the memory 48 of the controller 46 on the density of the hydraulic fluid and determine an aeration level, such as in terms of percent by volume, in the hydraulic fluid. Algorithms for determining the aeration level using the data provided by the sonic sensor system and the pressure sensor, as well as information regarding the density of the hydraulic fluid may be stored in the memory 48 associated with the controller 46. The computer readable memory 48 associated with the controller 46 may include random access memory (RAM) and/or read-only memory (ROM). The information stored in the memory 48 may be provided to a processor associated with the controller 46 so that the processor may determine the aeration level of the hydraulic fluid. Examples of processors include computing devices and/or dedicated hardware having one or more central processing units and microprocessors. One example of a sonic sensor system 42 and associated control system that can be used in the aeration sensing system are sensors and systems sold under the SONARtrac tradename by CiDRA of Wallingford, Conn.

The controller 46, sonic sensor system 42 and pressure sensor 44 may be configured to monitor the system aeration levels on a continuous basis providing information that can be input into a hydraulic system health monitoring system. In such a case, the aeration sensing system 40 may generate information regarding aeration levels in the hydraulic fluid on a real-time, or near real-time basis. Alternatively, the controller 46 may selectively activate the aeration sensing system 40 to take an aeration measurement at a desired time. For example, the controller 46 may operate the sonic sensor system 42 and the pressure sensor 44 to respectively generate speed of sound data and pressure data at regular time intervals. Alternatively, the controller 46 may operate the aeration sensing system 40 under select machine conditions. For example, the aeration sensing system 40 may operate only when the hydraulic pump 26 exceeds a threshold flow rate.

To provide a historical record of the aeration levels in the hydraulic fluid of the hydraulic power system 20 during operation of the mobile machine 10, the controller 46 may be configured to store aeration level data in memory 48. The memory 48 may be on the mobile machine 10, at a remote location, such as at an on-site or offsite management office, or both. The aeration data that is stored by the controller 46 may be associated with other data relating to the operation of the mobile machine 10. For instance, the aeration data may be stored in memory 48 in connection with time data provided for example by a clock or location data regarding the location of the mobile machine 10 provided by a location sensor. Additionally, the aeration data may be correlated with data regarding the inclination of the mobile machine 10, as changes in inclination can sometimes lead to the introduction of air into the hydraulic power system 20 such as through movement of the fluid in the reservoir 28. The controller 46 may also receive and process other machine parameter data that can be linked to the aeration level data. Such machine parameter data may be any data measured on the mobile machine 10, such as engine parameters, hydraulic system parameters, transmission state parameters, operator command parameters, and any other data gathered by an electronic control module on the mobile machine. These parameters may be correlated to more precisely determine an acceptable level of aeration in the hydraulic power system 20.

The aeration level data produced by the controller 46 and the aeration sensing system 40 could be input by the controller 46 into general health and failure prognostication algorithms also stored in the controller 46 or other control system on the mobile machine 10. In this way, the aeration level data could be used to help intercept catastrophic component failures. For example, the controller 46 could use the aeration level information to provide early warning of fluid loss or an adverse machine operating condition and signal the controller 46 to power down the engine 24 and associated systems and alert the operator so as to allow for mitigation of any damage to the hydraulic power system 10 components such as the hydraulic pump 26 and hydraulic motor 34. In this respect, the controller 46 can be configured to compare the measured or determined aeration level of the hydraulic fluid to a reference value and then command an action if the aeration level is greater than the reference value. The reference value may be predetermined by the level of aeration acceptable in the hydraulic power system 20. For example, the threshold value may be the highest level of aeration acceptable without causing undue adverse impacts on mobile machine performance, such as excessive noise, oxidation, or loss of efficiency. Alternatively, the controller 46 may calculate the reference value on an ongoing basis taking into other mobile machine parameters such as engine parameters, hydraulic system parameters, transmission parameters and/or operator command parameters. For example, aeration can cause more damage to hydraulic system components at higher pressures. Thus, the controller 46 may use, for example, the pressure data from the pressure sensor 44 to help set the reference value, such as by setting the reference value relatively lower when system pressure is higher.

Some of the actions that the controller 46 could command if the measured aeration level exceeds the reference value include shutting down or limiting the hydraulic power system 20 in its entirety, shutting down or limiting one or more components of the hydraulic power system 20 such as the hydraulic pump 26 or hydraulic motor 34 or to shut down or limit the mobile machine 10 itself. In particular, the controller 46 could direct a reduction in the speed of the engine 24. Additionally, the controller 46 could direct a reduction in the maximum pump displacement or pressure limit set point of the hydraulic pump 26 control system. The controller 46 also could direct activation of an audible or visual alarm on the display 23 in the cab 12. Alternatively or additionally, the mobile machine 10 may automatically send a signal to a central operator station, or to a service technician or service system, that the aeration of the liquid system is above the threshold level. The controller 46 also could log an alarm event in memory 48, such as with other machine fault information. Such information may be valuable in performing system failure analysis by providing an indication as to whether aeration levels contributed to the system failure.

### INDUSTRIAL APPLICABILITY

The present disclosure is applicable to any type of mobile machine that utilizes a hydraulic power system to power operation of an implement carried by the mobile machine and/or movement of the mobile machine. The aeration level information provided by the disclosed aeration sensing system is particularly accurate as compared to other aeration measurement systems. The aeration level information produced by the system can be used to help identify the cause of the failure more quickly and at a lower cost. Such aeration level information could also be used to identify design deficiencies in existing hydraulic power systems and allow for correction before component failure. Thus, the aeration sensing system can help reduce the need for costly repairs to a hydraulic power system. The aeration sensing system also could be used as a design validation tool during testing. In particular, the system could provide information that would help identify system components or operating conditions that adversely impact aeration levels.

In addition to hydraulic power systems, the aeration sensing system disclosed herein could be used to sense aeration levels in other fluid systems on mobile machines. For example, the aeration sensing system could be used with the fluid of an engine lubrication system, the fluid in an engine or machine coolant system and/or the fluid in a machine fuel system.

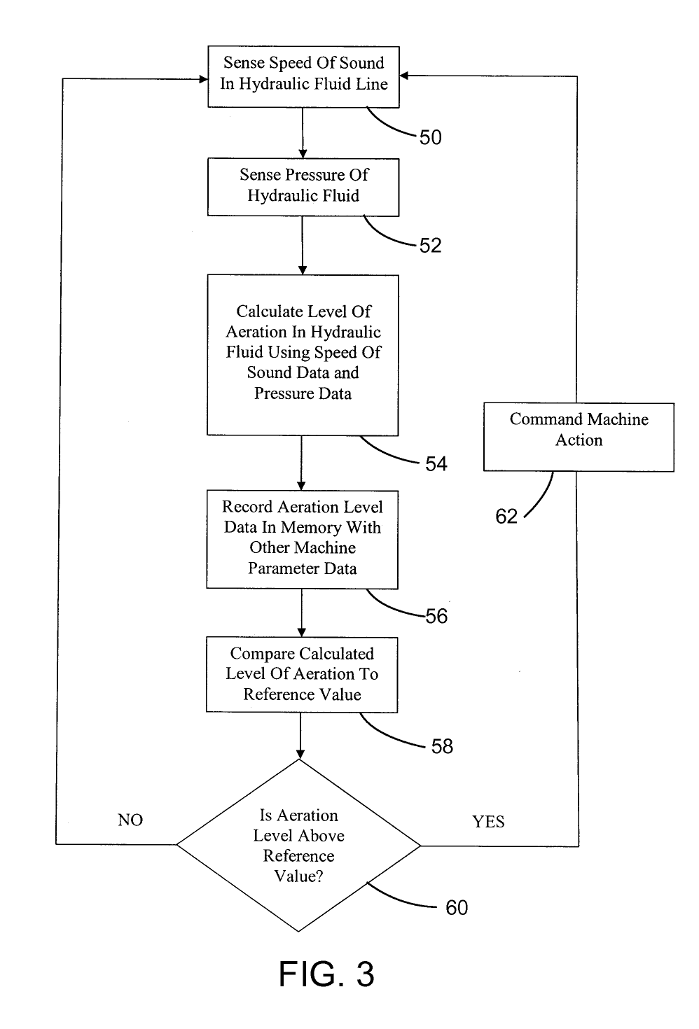

An exemplary method for controlling the hydraulic power system 20 that may be implemented by the controller 46 in connection with determining the aeration levels is shown in FIG. 3. The method shown in FIG. 3 begins in step 50 with sensing or collecting data regarding the speed of sound in the hydraulic fluid in a line of the hydraulic power system 20. As discussed above, this can be performed by the sonic sensor system 42 as directed by the controller 46. In step 52, the pressure of the hydraulic fluid in the hydraulic power system 20 is sensed. This can be performed by the pressure sensor 44 and communicated to the controller 46. It will be understood that steps 50 and 52 can be performed in any particular order or simultaneously. Next, in step 54, the level of aeration in the hydraulic fluid can be calculated using the speed of sound data collected in step 50, the pressure data collected in step 52. Information regarding the density of the hydraulic fluid could also be used in the calculation. This step 54 can be performed by the controller 46 using appropriate algorithms stored therein. Next, in step 56, the calculated aeration level from step 54 can be recorded in memory 48 in association with other machine parameter data. The other machine parameter data may include data regarding operation or performance of the engine 24 and/or the hydraulic power system 20 (e.g., the hydraulic pump 26 or motor 34) and or data relating to operator input commands, time and/or location of the mobile machine 10.

In step 58, the controller 46 may compare the calculated level of aeration from step 54 to a reference value for level of aeration. It should be understood, the recording of step 56 can occur after the comparison of step 58 and the recorded information may include an indication as to whether the aeration level exceeded the reference value. In step 60, the controller 46 may determine whether the calculated aeration level is above the reference value. If it is above the reference value, the method may proceed to step 62 where the controller 46 commands a machine action. Examples of machine actions that could be command are discussed above and can include activation of an alarm on the display 23 in the cab 12, shutting down or limiting operation of one or more components of the hydraulic power system 20 such as the hydraulic pump 26 or motor 34 and/or to shut down or limiting operation of the engine 24.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

I claim:

1. A hydraulic power system for a mobile machine comprising:
a load configured to be driven by pressurized hydraulic fluid;
a hydraulic pump operatively connected for supply pressurized hydraulic fluid to the load;
an engine operatively connected and configured to drive the hydraulic pump; and
an aeration sensing system comprising:
a sonic sensor system comprising a plurality of bands arranged on an outer surface of a line carrying pressurized hydraulic fluid, the sonic sensor system being configured to produce speed of sound data relating to a speed of sound in the hydraulic fluid in the line;
a pressure sensor configured to produce pressure data relating to a pressure of the hydraulic fluid in the line; and
a controller in communication with the sonic sensor system and the pressure sensor and configured to calculate a level of aeration in the hydraulic fluid in the line during mobile machine operation using the speed of sound data and the pressure data.

2. The hydraulic power system of claim 1 wherein the controller is configured to compare the calculated level of aeration with a reference value of aeration and command a machine action if the calculated level of aeration exceeds the reference value of aeration.

3. The hydraulic power system of claim 2 wherein the machine action command by the controller is providing an alarm.

4. The hydraulic power system of claim 2 wherein the machine action command by the controller is adjusting operation of at least one the engine and the hydraulic pump.

5. The hydraulic power system of claim 2 wherein the machine action commanded by the controller is recording an alarm event in a memory.

6. The hydraulic power system of claim 1 wherein the controller is configured to record the calculated aeration level in a memory.

7. The hydraulic power system of claim 6 wherein the controller monitors a machine parameter associated with at least one of the engine and the hydraulic pump and wherein the controller records the calculated aeration level in the memory in association with the machine parameter.

8. The hydraulic power system of claim 1 wherein the controller uses information relating to a density of the hydraulic fluid in the line in calculating the level of aeration.

9. A method for operating a hydraulic power system of a mobile machine that is configured to power operation of a load associated with the mobile machine, the method comprising the steps of:
sensing a speed of sound in a line carrying pressurized hydraulic fluid that is in communication with the load using a sonic sensing system including a plurality of bands arranged on an outer surface of the line;
sensing a pressure of the hydraulic fluid in the line;
monitoring a machine parameter associated with operation of an engine of the mobile machine or a hydraulic device of the hydraulic power system;
calculating a level of aeration in the hydraulic fluid in the line using the speed of sound in the line and the pressure of the hydraulic fluid in the line;
comparing the calculated level of aeration in the hydraulic fluid in the line to a reference value of aeration;
recording in memory the calculated level of aeration in association with the machine parameter; and
commanding an action if the calculated level of aeration exceeds the reference value of aeration.

10. The method of claim 9 wherein the action is providing an alarm.

11. The method of claim 9 wherein the action is adjusting operation of at least one the engine and the hydraulic pump.

12. The method of claim 9 wherein the action is recording an alarm event in a memory.

13. The method of claim 9 wherein information relating to a density of the hydraulic fluid in the line is used in calculating the level of aeration with the speed of sound in the line and the pressure of the hydraulic fluid in the line.

14. A mobile machine comprising:
a chassis;
a plurality of ground engaging elements supported by the chassis for propelling the mobile machine;
a work implement supported on the chassis; and
a hydraulic power system comprising:
a hydraulic pump supplying pressurized hydraulic fluid to drive at least one of the work implement and the ground engaging elements;
an engine operatively connected and configured to drive the hydraulic pump; and
an aeration sensing system comprising:
a sonic sensor system comprising a plurality of bands arranged on an outer surface of a line carrying pressurized hydraulic fluid, the sonic sensor system being configured to produce speed of sound data relating to a speed of sound in the hydraulic fluid in the line;
a pressure sensor configured to produce pressure data relating to a pressure of the hydraulic fluid in the line; and
a controller in communication with the sonic sensor system and the pressure sensor and configured to calculate a level of aeration in the hydraulic fluid in the line during mobile machine operation using the speed of sound data and the pressure data.

15. The mobile machine of claim 14 wherein the controller is configured to compare the calculated level of aeration with a reference value of aeration and command a machine action if the calculated level of aeration exceeds the reference value of aeration.

16. The mobile machine of claim 15 wherein the machine action command by the controller is providing an alarm.

17. The mobile machine of claim 15 wherein the machine action command by the controller is adjusting operation of at least one the engine and the hydraulic pump.

18. The mobile machine of claim 15 wherein the machine action commanded by the controller is recording an alarm event in a memory.

19. The mobile machine of claim 14 wherein the controller is configured to record the calculated aeration level in a memory.

20. The mobile machine of claim 19 wherein the controller monitors a machine parameter associated with at least one of the engine and the hydraulic pump and wherein the controller records the calculated aeration level in the memory in association with the machine parameter.
